(19) United States
(12) Patent Application Publication
(10) Pub. No.: US 2010/0281653 A1
(43) Pub. Date: Nov. 11, 2010

(54) Bidirectional Hinge

(76) Inventor: Zong-Ying LIN, Danshuei Township (TW)

Correspondence Address: Muncy, Geissler, Olds & Lowe, PLLC, 4000 Legato Road, Suite 310, FAIRFAX, VA, 22033, US

(21) Appl. No.: 12/194,350

(22) Filed: Aug. 19, 2008

(51) Int. Cl. E05F 1/14; E05F 1/12

(52) U.S. Cl. 16/285

(57) ABSTRACT

A bidirectional hinge is used to pivot between two independent devices, allowing the two independent devices to be opened and closed with respect to each other after being pivoted. A structure and feature of a coiled spring is applied to the hinge, such that the hinge can rotate clockwise and counterclockwise according to requirements, and different torsional force depending upon a direction of rotation can be resulted, so as to increase application requirements.

### BACKGROUND OF THE INVENTION

a) Field of the Invention

The present invention relates to a bidirectional hinge which enables two independent devices to be opened and closed with respect to each other after being assembled together, and more particularly to a bidirectional hinge which can result in different torsional force depending upon that whether the hinge rotates clockwise or counterclockwise.

b) Description of the Prior Art

A hinge is used rather widely and its primary function is to serve as a part to bridge two independent devices. In an ordinary application, two independent devices are assembled at an end of the hinge, respectively. After being assembled, the two independent devices are formed as a relative relation of assembly and can be opened or closed with respect to each other by the relative rotation of the hinge. The most common application is to use two ends of a hinge to bridge a base and a screen of a laptop computer, such that the base and the screen can be opened or closed with respect to each other, after being bridged. Another example is a flip-type cellular phone or other flip-type electronic device. Referring to FIG. 1, it shows a three-dimensional view of a conventional hinge, wherein the hinge 10 includes primarily a housing 101, a wrap-band 102, a shaft 103 and an adapter 104. The adapter 104 and the shaft 103 are assembled in an L shape and can be formed integrally. An end of the shaft 103 passes through a housing hole 1011, penetrates the wrap-band 102, and is then fixed at a housing hole 1012 at the other end. After being transfixed, the shaft 103 is fixed by a snap ring 105, allowing the shaft 103 to rotate between the band and housing holes 1011, 1012. On the other hand, the wrap-band 102 is formed with a notch to constitute a proper stopper. In addition, as the wrap-band 102 is provided with an inner diameter that is a little smaller than an outer diameter of the shaft 103, when the shaft 103 rotates, it will be clamped by the wrap-band 102. Due to a stress of the wrap-band 102, the shaft 103 can still rotate upon being acted by proper force and friction.

As shown in the drawing again, normally, an outer circumferential surface of the shaft 103 can be inserted with a stop pin 1031. Therefore, when the shaft 103 rotates, it can be limited to proper rotating angles by a band's notch. Although this kind of hinge can allow the two independent devices to be opened or closed with respect to each other after assembling the two devices, if the requirement of an application is to lift up one device gently, and minimum supporting force of falling is concerned, then the requirement of usage will not be satisfied properly. For example, according to a habit of utilization for a laptop computer, when the screen is to be lifted up an angle, it is will normally be larger than 90 degrees (between the base and the screen). As the screen is usually designed as a thin-type device, if the force needed to lift up the screen is too large (assuming the demanding torque is A), then it is possible that the screen will be ruptured and damaged due to improper acting of force upon lifting open the screen. Furthermore, when the angle between the screen and the base is smaller than 90 degrees, then the hinge should provide proper torque (assuming the demanding torque is B). Ideally, the demanding torque A should be smaller than the demanding torque B; in other words, when lifting up the screen, the demanding torque A should be as small as possible but cannot be zero nor can be smaller than the demanding torque for a weight of screen. It is because that when the interior angle between the screen and the base is larger than 90 degrees, the screen is not allowed to manifest a state of zero torque demand, otherwise the screen may fall down. On the other hand, when the interior angle between the screen and the base is smaller than 90 degrees, the proper demand of torque is also required to support the screen that the screen will not be covered on the base directly, thereby preventing the screen to be covered on the base too quickly to result in the damage of the screen. Accordingly, to be in compliance with ergonomics, the common angle after lifting up the screen is between about 110 degrees to 120 degrees. At this time, the torque is actually required to lift up the screen changes with cos “θ.” When “θ” is 0 degree, cos “0” is 1, and it means that the torque at this point is taken to be the utmost basic demand. Moreover, if the screen is lifted to cos(45°), which is equal to about 0.7, then the torque at this point is quite about 70% of the largest demand. Hence, when the screen is lifted to 90 degrees (or cos(90°)), its value is zero, and the demand of torque is smallest. Following that, the screen is gradually lifted to a larger angle and stops at 120 degrees. In reality, if one hinge can provide a unidirectional requirement, too large torque is not needed when the screen is lifted up to 0˜90°. In this range, if the screen can be lifted up just by its weight, and the screen can be supported to prevent from dropping down momentarily, then the requirement of a user can be satisfied. However, this kind of requirement is contradictory to a design of a conventional hinge structure. That is to say, the aforementioned requirement is an ideal operational mode and it is very difficult to achieve the aforementioned requirement in terms of the existing hinge. The design of an ordinary hinge, as shown in FIG. 1, has been rather simplified; yet, the demanding torque is the same when the hinge rotates clockwise and counterclockwise. Accordingly, it is unable to satisfy the ideal requirement of operation in different torque when the hinge rotates clockwise and counterclockwise.

### SUMMARY OF THE INVENTION

Accordingly, the primary object of the present invention is to provide a bidirectional hinge which results in a proper change of torsional force depending upon that whether the hinge rotates clockwise or counterclockwise, so as to better comply with a requirement of operation.

In order to achieve the aforementioned object, the present invention uses primarily a coiled spring as an interfering part to limit rotation of a shaft, such that a proper demanding torque can be produced by further limiting an extent of force acting when the shaft rotates, using a change of an inner diameter of the spring when the spindle rotates upon being acted by the force. In addition, when implementing the present invention, a spring of a various number of loops of wire winding, a spring of a different wire diameter or a spring of a different wire type can be further selected depending on all kinds of torsional force demand, thereby better improving the practicability.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional view of a conventional hinge.

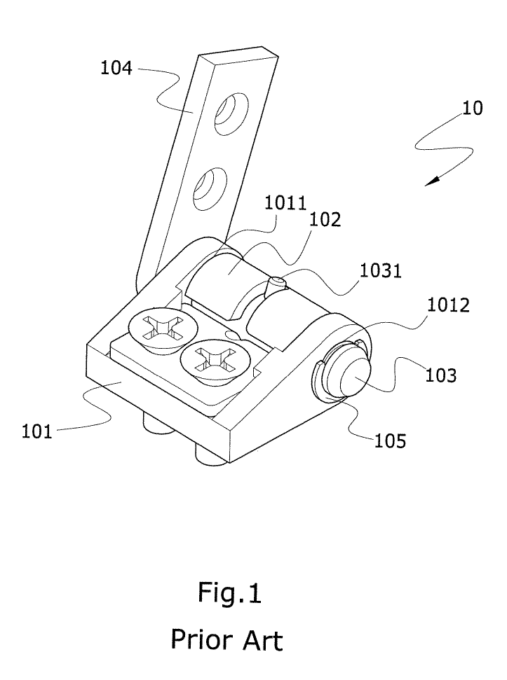

FIG. 2 shows a three-dimensional view of the present invention.

FIG. 3 shows a schematic view of parts constituting the present invention.

FIG. 4 shows a cutaway view of an operation of the present invention.

FIG. 5 shows a schematic view of another preferred embodiment of the present invention.

FIG. 6 shows a schematic view of still another preferred embodiment of the present invention.

FIG. 7 shows schematic view of an application of the present invention.

### DETAILED DESCRIPTION OF THE PREFERRED EMBODIMENTS

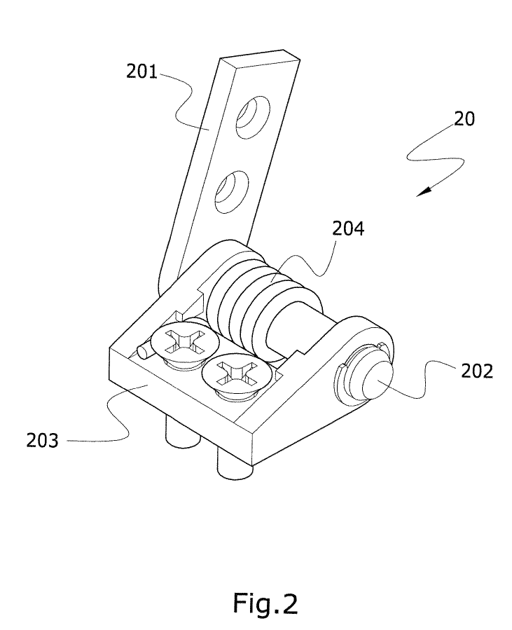

Referring to FIG. 2, it shows a three-dimensional view of the present invention, wherein a bidirectional hinge 20 comprises primarily an adapter 201, a shaft 202, a housing 203, and a coiled spring 204. The adapter 201 and the shaft 202 are mutually perpendicular, or they can be also formed integrally in an L shape. An end of the shaft 202 is assembled into the housing 203 and the shaft 202 drive the coiled spring 204 to serve as an elastic limiting part. The shaft 202 can swing to an angle clockwise and counterclockwise according to a proper condition of torsional force, and as the adapter 201 is assembled with an end of the shaft 202 (assembled together or formed integrally), the adapter 201 can serve as a point of force acting upon rotating by the force, such that when the adapter 201 swings clockwise and counterclockwise by the force, the shaft 202 is driven to rotate as well.

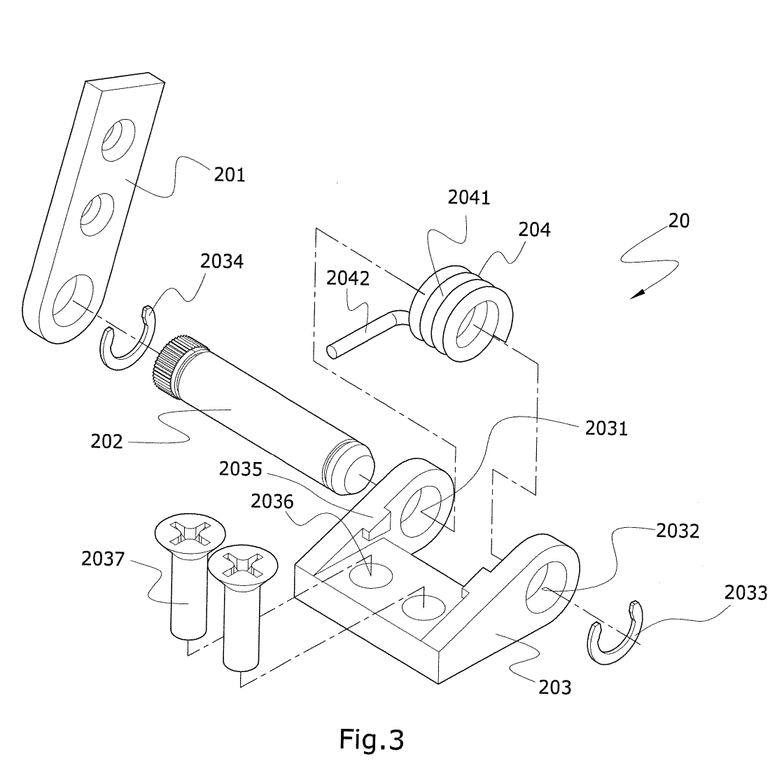

Referring to FIG. 3, it shows a schematic view of parts constituting the present invention, wherein two sides of the housing 203 are formed vertically with a housing hole 2031 and the other housing hole 2032, respectively; an end of the spindle 202 is transfixed into the shaft hole 2031 first and then transfixed into the coiled spring 204 before that a tail end of the spindle 202 is fixed at the shaft hole 2032 with a C-shape spring 2033. After being fixed, the spindle 202 is pivoted with the bottom seat 203; that is, the spindle 202 can rotate against the shaft holes 2031, 2032. In addition, the other end of the shaft 202 is assembled with the adapter 201 before being fixed by another snap ring 2034, or the shaft 202 and the adapter 201 can be formed integrally. As shown in the drawing again, the coiled spring 204 is formed with a coiled part 2041, and a last end that is protruded out of the coiled part 2041 is a limiting part 2042. After being assembled, the limiting part 2042 is exactly located at a pressing part 2035 on the housing 203 to prevent the coiled spring 204 from resulting idle rotation in a Y-axis due to rotation of the shaft 202. On the other hand, a screw 2037 is locked into a through-hole 2036 that is formed on a surface of the housing 203 to accomplish locking in the Y-axis, thereby allowing the limiting part 2042 of the coiled spring 204 to be limited in an X-axis, so as to prevent the coiled spring 204 from being displaced horizontally. The entire hinge is assembled as shown in FIG. 2. Moreover, an inner diameter of the coiled spring 204 should be equal to or a little smaller than an outer diameter of the shaft 202, such that after the shaft 202 has been inserted into the coiled spring 204, the coiled spring 204 can tightly abut the shaft 202 to form a proper interference. Therefore, when the shaft 202 rotates, the coiled part 2041 of the coiled spring 204 can be loosened or tightened according to a direction of wire winding, following the direction of rotation due to the interference. When the direction of rotation of the shaft 202 enables the coiled part 2041 to be loosened, the torque will become smaller; whereas, when the coiled part 2041 is tightened due to the direction of rotation, the torsional force required will be increased. Accordingly, more than two different torsional force requirements will be produced depending upon the direction of rotation, i.e., clockwise or counterclockwise. Furthermore, the change of torsional force requirement can be pre-defined in manufacturing; for example, a loop number of wire winding of the spring, a wire diameter of the spring or a wire type of the spring can be selected after calculation, so as to produce the coiled spring of various torque requests.

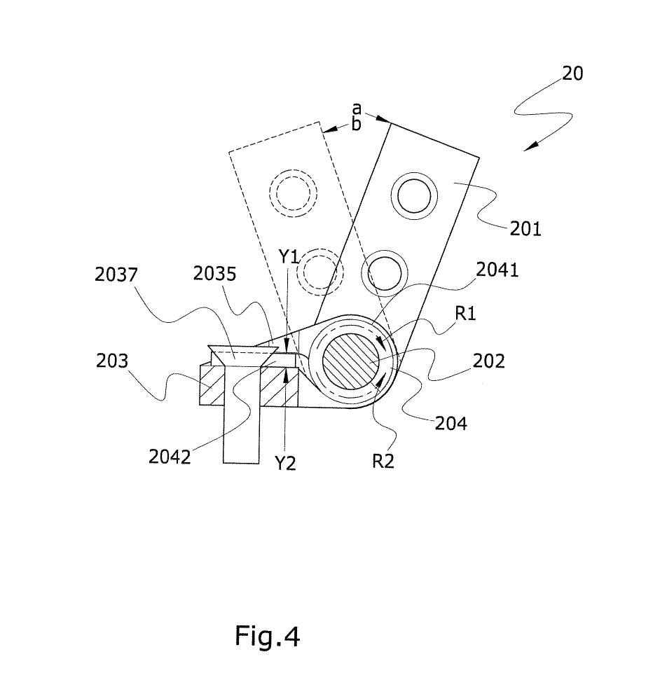

Referring to FIG. 4, it shows a cutaway view of an operation of the present invention, wherein with a center point of the shaft 202 as a rotation center, the adapter 201 can swing clockwise and counterclockwise depending upon the direction of force acting. As shown in the drawing, the coiled spring 204 is wound counterclockwise, and conditions of operation upon application are described below:
(1) When the shaft 202 rotates clockwise, or when the adapter 201 swings clockwise by force “a”, as the outer diameter of the shaft 202 is roughly interfered with the inner diameter of the coiled part 2041 of the coiled spring 204, the coiled part 2041 can rotate to open a lithe along a clockwise direction (R1) upon that the shaft 204 rotates clockwise (because the limiting part 2041 of the coiled spring 204 is limited by a limiting point Y1), which likes that the coiled part 2041 is loosened, or that the interference between the shaft 202 and the coiled part 2041 is released. Therefore, when the shaft 202 rotates, the torsional force required will be reduced. If in manufacturing, the default torsional force of the coiled part 2041 of the coiled spring 204 is configured properly, then the torsional force demand of a single rotating direction (clockwise in this embodiment) of the bidirectional hinge can be decreased properly. For example, when being applied to a screen of a laptop computer, the torsional force for lifting open the screen should be smaller than that for covering the screen, and should be as small as possible to prevent the screen from being ruptured or damaged by acting too large force to the screen when a user is lifting open the screen.
(2) When the spindle 202 rotates counterclockwise, or the adapter 201 swings counterclockwise by force b, the interference between the shaft 202 and the coiled part 2041 will allow the coiled spring 204 to be gradually tightened along a counterclockwise direction (R2) (because the limiting part 2042 of the coiled spring 202 is limited by a limiting point Y2); in other words, the torsional force required will be increased gradually. Therefore, the force b needs to be increased again that the adapter 201 can swing counterclockwise. For example, when being applied to the screen of the laptop computer, when covering the screen, it needs to assure that abrupt press down will not be resulted by weight of the screen upon covering to damage the screen, by considering an angle of covering and the weight of the screen. Accordingly, the proper torsional force (supporting force) is still required to allow the screen to be acted by the proper force that the screen can be pressed down slowly to a dead point to cover.

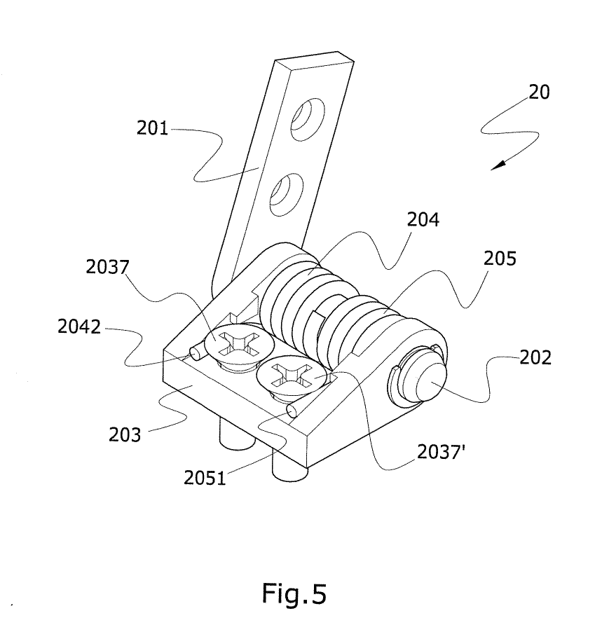

Referring to FIG. 5, it shows a schematic view of another preferred embodiment of the present invention, wherein when applying the present invention, a structure of equal bidirectional torsional force can be formed. As shown in the drawing, only another set of reverse coiled spring 205 is added that the torsional force can be balanced between the clockwise and counterclockwise directions. In other words, when the same shaft 202 rotates, a corresponding interference stress is resulted to the coiled spring 204 and the reverse coiled spring 205 respectively, and this coefficient of interference stress can be designed as a balanced torsional force or a large difference of the torsional force between the clockwise and counterclockwise directions. Moreover, as shown in the drawing, the screws 2037, 2037′ are locked at the bottom seat 203 respectively, and abut the limiting parts 2042, 2051 that are protruded out of the two springs. In addition, the screws 2037, 2037′ used for abutting can be an inner-cone screw to achieve an effective abutting function.

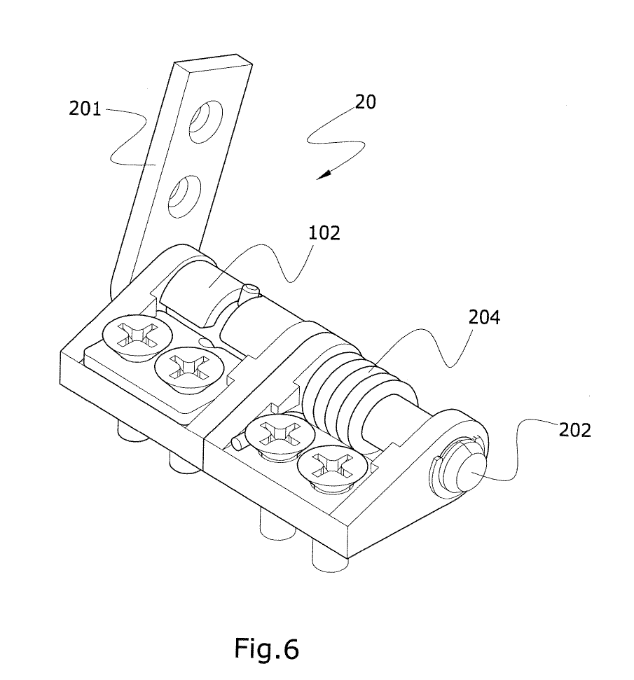

Referring to FIG. 6, it shows a schematic view of still another preferred embodiment of the present invention, wherein the present invention can be also fitted with a conventional wrap-band 102 for a practical application. As shown in the drawing, when an application of a high torsional force demand is needed, the coiled spring 204 of the bidirectional hinge 20 of the present invention can be assembled coaxially with the wrap-band 102 to result in a large difference of the torsional force between the clockwise and counterclockwise directions. For example, when a screen part of a laptop computer is lifted up, the screen will not fall down disregarding the lifting angle, only considering weight of the screen body.

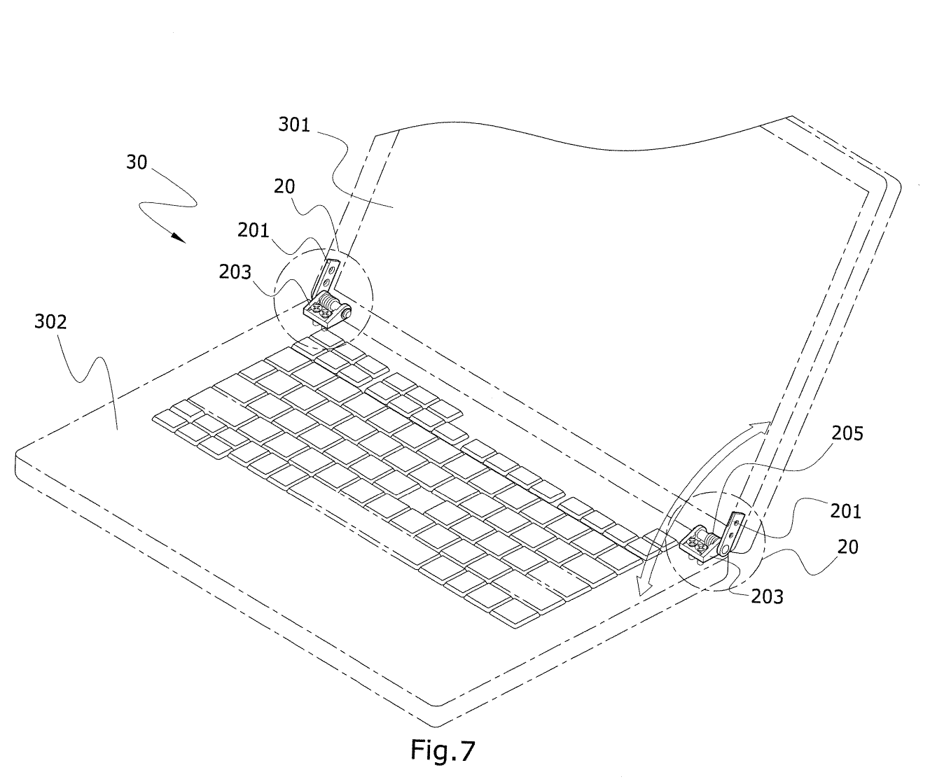

Referring to FIG. 7, it shows a schematic view of an application of the present invention, wherein a laptop computer 30 is primarily constituted by a screen 301 and a host seat 302, between which are installed with the bidirectional hinge 20 of the present invention. As shown in the drawing, the bottom seat 203 of the bidirectional hinge 20 can be fixed on a surface of the host seat 302 or can be embedded in the host seat 302; whereas, the adapter 201 of the bidirectional hinge 20 is assembled at the screen 301. Accordingly, the screen 301 and the host seat 302 are assembled together, and the screen 301 and the bottom seat 203 that is assembled at the host seat 302 can be pivoted together by the adapter 201. After being assembled, the screen 301 and the host seat 302 can be opened and closed with respect to each other. In addition, the other side opposite to the bidirectional hinge 20 is provided with the reverse coiled spring 205. Therefore, when the user opens the screen 301, only very small force needs to be acted that the screen 301 can be lifted open. On the other hand, after the screen 301 has been lifted open, the proper torsional force demand can be maintained disregarding the angle, so as to assure that the screen 301 can be stopped at any angle.

Accordingly, the present invention employs primarily the proper interference between the shaft and the coiled spring to drive the coiled spring with the interference stress when the spindle rotates, allowing the inner diameter of the coiled spring to be loosened or tightened a little according to the rotating direction of the shaft. Hence, the demanding torque will be gradually decreased or increased when the shaft rotates, so as to better comply with the requirement upon operating the hinge. In addition, the parts of the present invention are simple, the torsional force can be pre-defined, and the loop number of wire winding, the wire diameter or the wire type can be selected according to the required torsional force (e.g., a circular cross-section spring or a polygonal spring) in manufacturing the coiled spring. Accordingly, after implementation, the bidirectional hinge that results in the change of proper torsional force depending upon the clockwise and counterclockwise rotation can be actually achieved, so as to better comply with the requirement of operation.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A bidirectional hinge which pivots between two independent devices, enabling the two independent devices to be pivoted with respect to each other that the two devices are opened and closed with respect to each other, comprising:
an adapter and a shaft, which are formed in an L-shape; and
a housing, which is formed with a supporting hole to twins, with the shaft being transfixed into the housing holes and assembled with a coiled spring that is formed with a limiting part, and the limiting part being limited by the housing; an outer diameter of the shaft being roughly interfered with an inner diameter of the coiled spring, such that a change of torsional force is resulted by the coiled spring, depending upon a direction of rotation of the spindle, using a stress produced by the interference when the shaft rotates.

2. The bidirectional hinge according to claim 1, wherein the housing is formed with more than one pressing part to press the limiting part of the coiled spring.

3. The bidirectional hinge according to claim 1, wherein a surface of the housing is formed with a twin holes to support the shaft and the coiled spring combination, after being transfixed by a screw.

4. The bidirectional hinge according to claim 3, wherein the screw is an inner-cone screw.

5. The bidirectional hinge according to claim 1, wherein the other end of the shaft is assembled with a reverse coiled spring which produces opposite torsional force to function as a balance operation, when the shaft rotates.

6. The bidirectional hinge according to claim 1, wherein the other end of the shaft is assembled with a wrap-band to produce a large relative difference of torsional force.

7. The bidirectional hinge according to claim 1, wherein a relative torsional force difference is available when the adapter rotates clockwise and counterclockwise.

8. The bidirectional hinge according to claim 1, wherein another set of bidirectional hinge having a reverse coiled spring is further fitted, with the bidirectional hinge being assembled between a host base and a screen of a laptop computer, enabling the host base and the screen to be opened and closed with respect to each other.
